(19) United States
(12) Patent Application Publication
(10) Pub. No.: US 2010/0214244 A1
(43) Pub. Date: Aug. 26, 2010

(54) ELECTRONIC DEVICE AND METHOD FOR CONTROLLING ELECTRONIC DEVICE

(75) Inventor: Hyun Ok KIM, Bucheon-si (KR)

Correspondence Address: H.C. PARK & ASSOCIATES, PLC, 8500 LEESBURG PIKE, SUITE 7500, VIENNA, VA, 22182, US

(73) Assignee: PANTECH CO., LTD., Seoul (KR)

(21) Appl. No.: 12/698,405

(22) Filed: Feb. 2, 2010

(30) Foreign Application Priority Data
Feb. 23, 2009 (KR) 10-2009-0015015

(51) Int. Cl. G06F 3/041

(52) U.S. Cl. 345/173

(57) ABSTRACT

An electronic device includes an infrared temperature sensor and can detect a user's finger arranged within a detection distance even though the user's finger does not contact the electronic device. Movement of the user's finger is also detected. A pointer positioned and moving according to the position and movement of the user's finger is displayed on a screen of the portable electronic device, and a predetermined function corresponding to the movement of the finger may be performed. A method for controlling the electronic device includes detecting that a user's finger is positioned within a detection distance of an infrared temperature sensor, and displaying a pointer corresponding to a position of the user's finger on a display screen. The method also may include moving the pointer or performing a function corresponding to the movement direction of the pointer.

### CROSS-REFERENCE TO RELATED APPLICATION

This application claims priority from and the benefit of Korean Patent Application No. 10-2009-0015015, filed on Feb. 23, 2009, which is hereby incorporated by reference for all purposes as if fully set forth herein.

### BACKGROUND OF THE INVENTION

1. Field of the Invention

This disclosure relates to an electronic device and a method for controlling an electronic device, and more particularly, to an electronic device and a method for controlling an electronic device according to movement of a user's finger arranged within a detection distance of the electronic device without contacting the electronic device.

2. Discussion of the Background

As the electronics technology has developed, various electronic devices have been developed, some of which are portable such as a portable media player, a portable DMB TV, and a portable telephone.

Recently, in order to increase utility for a user, a portable electronic device with a touch screen has been developed.

In the portable electronic device equipped with a touch screen, a command may be input to the device to control the portable electronic device by touching the touch screen with a user's finger, a touch pen or stylus, or a sharp object.

In the existing portable electronic device controlled by an input through the touch screen, an input error caused by a different size of the user's finger may occur when the user touches the touch screen with a finger, or physical damage to the touch screen may occur due to the repeated touch on the touch screen by using a user's finger, a touch pen or stylus, or a sharp object. Such damage may reduce the life span of the portable electronic device.

### SUMMARY OF THE INVENTION

Exemplary embodiments of the present invention provide an electronic device and a method for controlling an electronic device that may detect the presence or movement of a user's finger arranged within a detection distance of the portable electronic device without contacting the electronic device.

Exemplary embodiments of the present invention also provide an electronic device and a method for controlling an electronic device that may perform a predetermined function corresponding to a detected movement of a user's finger arranged within the detection distance of the portable electronic device without contacting the electronic device.

Additional features of the invention will be set forth in the description which follows, and in part will be apparent from the description, or may be learned by practice of the invention.

An exemplary embodiment of the present invention discloses an electronic device including: an infrared temperature sensor to detect a temperature of infrared emission energy emitted from a user's finger arranged within a detection distance of the infrared temperature sensor, and to output detected temperature information; a display screen; and a controller to recognize a position or movement of the user's finger on the basis of the temperature information, and to display on the display screen a pointer corresponding to the position or movement of the user's finger.

An exemplary embodiment of the present invention discloses a method for controlling an electronic device including: detecting a user's finger positioned within a detection distance of an infrared temperature sensor, and displaying a pointer corresponding to a position of the user's finger on a display screen of the electronic device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an electronic device according to an exemplary embodiment of the invention.

FIG. 2 is a flowchart for explaining a method for controlling an electronic device according to an exemplary embodiment of the invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. It will be further understood that the terms “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

Hereinafter, exemplary embodiments will be described in detail with reference to the accompanying drawings.

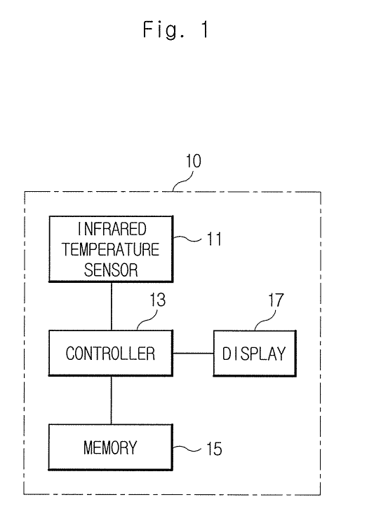

As shown in FIG. 1, an electronic device 10 may include an infrared temperature sensor 11, a controller 13, a memory 15, and a display 17.

The infrared temperature sensor 11 may be arranged in the vicinity of the display 17. The infrared temperature sensor 11 detects the presence of a user's finger by detecting temperature, and detects the movement of the user's finger while within a detection distance. The user's finger does not need to contact the display 17 to be detected by the infrared temperature sensor 11. That is, the infrared temperature sensor 11 may be a non-contact temperature sensor. The non-contact temperature sensor may include one of a radiation pyrometer and an optical pyrometer. Generally, a measurement range of a thermometer is represented as an index indicating a proportion of a measurement distance to the size of an object to be measured, i.e. the distance-to-spot ratio D:S. For example, with a measurement range of 10:1, a size of 10 cm or larger can be measured at a distance of 100 cm. Depending on sensor types, measurement ranges of 10:1, 15:1, 20:1, or 30:1 may be allowed. The temperature of infrared emission energy emitted from a user's finger within the detection distance is detected and the detected temperate information is input to the controller 13 so that the controller 13 may recognize the presence and/or movement of the user's finger.

If the infrared temperature sensor 11 detects the temperature of the infrared emission energy emitted from the user's finger and generates temperature information in a digital data type that can be read by the controller 13. The temperature information is then output to the controller 13 so the controller 13 recognizes the presence and/or movement of the user's finger.

If a user moves a finger while within the detection distance of the infrared temperature sensor 11, which corresponds to a distance within which the infrared temperature sensor 11 can detect temperature, an energy spot formed by the infrared emission energy emitted from the finger also moves corresponding to the movement of the user's finger. The infrared temperature sensor 11 detects the temperature of the energy spot which moves corresponding to the movement of the user's finger and inputs the temperature information to the controller 13 to allow the controller 13 to perceive the movement of the energy spot corresponding to the movement of the user's finger and recognize the movement of the user's finger.

As described above, the infrared temperature sensor 11 detects the temperature of the infrared emission energy emitted from the user's finger positioned within the detection distance and inputs temperature information to the controller 13 to allow the controller 13 to recognize the movement of the user's finger within the detection distance of the infrared temperature sensor 11 on the basis of the temperature information.

The controller 13 controls the operations of the electronic device 10 according to predetermined programs stored in the memory 15, which may be incorporated into the controller 13, or may be a separate memory, such as an internal flash memory or a removable memory device such as a memory card. Specifically, the controller 13 recognizes the movement of the user's finger while within the detection distance of the infrared temperature sensor 11 on the basis of the temperature information input from the infrared temperature sensor 11, displays a pointer which moves corresponding to the movement of the user's finger, and performs a predetermined function corresponding to the recognized movement of the user's finger.

If the user moves a finger while within the detection distance of the infrared temperature sensor 11, since the energy spot formed by the infrared emission energy emitted from the user's finger also moves corresponding to the movement of the user's finger, the controller 13 can receive the temperature information on the movement of the energy spot from the infrared temperature sensor 11. Accordingly, the controller 13 perceives the movement of the energy spot corresponding to the movement of the user's finger, recognizes the movement of the user's finger, displays the pointer which moves corresponding to the movement of the finger on the screen of the display 17, and may perform a predetermined function corresponding to the movement of the user's finger. In this way, the user can control the electronic device 10 through the movement of the finger without contacting the electronic device 10.

If the user's finger is positioned within the detection distance of the infrared temperature sensor 11, the controller 13 displays the pointer which moves according to the movement of the user's finger on the screen of the display 17, and may perform a predetermined function corresponding to the movement. For example, if a finger moves in a vertical direction within the detection distance of the infrared temperature sensor 11, moves horizontally in upward, downward, left or right directions within the detection distance of the infrared temperature sensor 11, or moves circularly, triangularly, horizontally or in other registered symbol shapes within the detection distance of the infrared temperature sensor 11, the controller 13 may perform a function corresponding to the movement of the finger. In this way, the user can control the electronic device 10 through the registered movement of the finger. For clarification, the vertical finger motion may approximately appear like a “double-click” finger motion on the display 17, although the finger does not need to contact the display 17 at the lowest point. The horizontal finger motion may approximately appear like a “swipe” finger motion on the display 17, although the finger does not need to contact the display 17. Thus, for the purpose of the specification, the terms “vertical” and “horizontal”, and variations or derivations thereof, are used with reference to the display 17 while arranged in the horizontal direction. Thus, a horizontal finger motion may be approximately parallel to the surface of the display 17, while the vertical finger motion may be approximately orthogonal to the surface of the display 17. These terms are used for reference only, however, and do not limit the position, arrangement, or orientation of the electronic device 10 when practicing the exemplary embodiments.

In addition, the controller 13 controls the operations of the electronic device 10 according to the programs stored in the memory 15, and when the electronic device 10 is operated, it displays information on the operation of the electronic device 10 on the display 17 to show the information visually. Specifically, the controller 13 displays the pointer, which moves corresponding to the movement of the user's finger as recognized by the infrared temperature sensor 11, on the screen of the display 17, recognizes the movement of the user's finger, and may perform a predetermined function according to an application executed in correspondence with the movement.

For example, if the user moves a finger vertically within the detection distance of the infrared temperature sensor 11 two times, the controller 13 may recognize the movement, moves the pointer on the screen of the display 17 according to the movement of the user's finger, and performs an “OK” process on the selected function to execute the function selected by the user. If the user moves a finger vertically within the detection distance of the infrared temperature sensor 11, and specifically, if the user moves the finger vertically in the downward direction, as the distance between the infrared temperature sensor 11 and the finger is decreased, the infrared temperature sensor 11 detects higher temperature. If the user moves the finger vertically or away from the display 17, as the distance between the infrared temperature sensor 11 and the finger is increased, the infrared temperature sensor 11 detects a lower temperature. As such, the movement of finger in the vertical direction can be detected.

In addition, if the user moves the finger horizontally in the upward direction within the detection distance of the infrared temperature sensor 11, the controller 13 may recognize the movement and performs a process such as a page up function of the screen displayed on the display 17 or a volume up function of a sound source that is being played according to the application being executed. In addition, if the user moves the finger horizontally in the downward direction within the detection distance of the infrared temperature sensor 11, the controller 13 may recognize the movement and performs a process such as a page down function of the screen displayed on the display 17 or a volume down function of the sound source that is being played according to the application being executed.

In addition, for example, if the user moves the finger horizontally in the left direction within the detection distance of the infrared temperature sensor 11, the controller 13 may recognize the movement and performs a process such as scrolling of the screen displayed on the display 17 to the left or playing a previous sound source according to the application being executed. If the user moves the finger horizontally in the right direction within the detection distance of the infrared temperature sensor 11, the controller 13 may recognize the movement and performs a process such as scrolling of the screen displayed on the display 17 to the right or playing a next sound source according to the application being executed.

In addition, for example, if the user moves a finger horizontally in a circular shape within the detection distance of the infrared temperature sensor 11, the controller 13 may recognize the movement and performs a process such as pausing the played sound source according to the application being executed. If the user moves the finger horizontally in a triangular shape within the detection distance of the infrared temperature sensor 11, the controller 13 may recognize the movement and performs a process such as resuming the paused sound source according to the application being executed. If the user moves the finger horizontally in other shapes within the detection distance of the infrared temperature sensor 11, the controller 13 may recognize the movement and performs a process corresponding to the movement according to the application being executed.

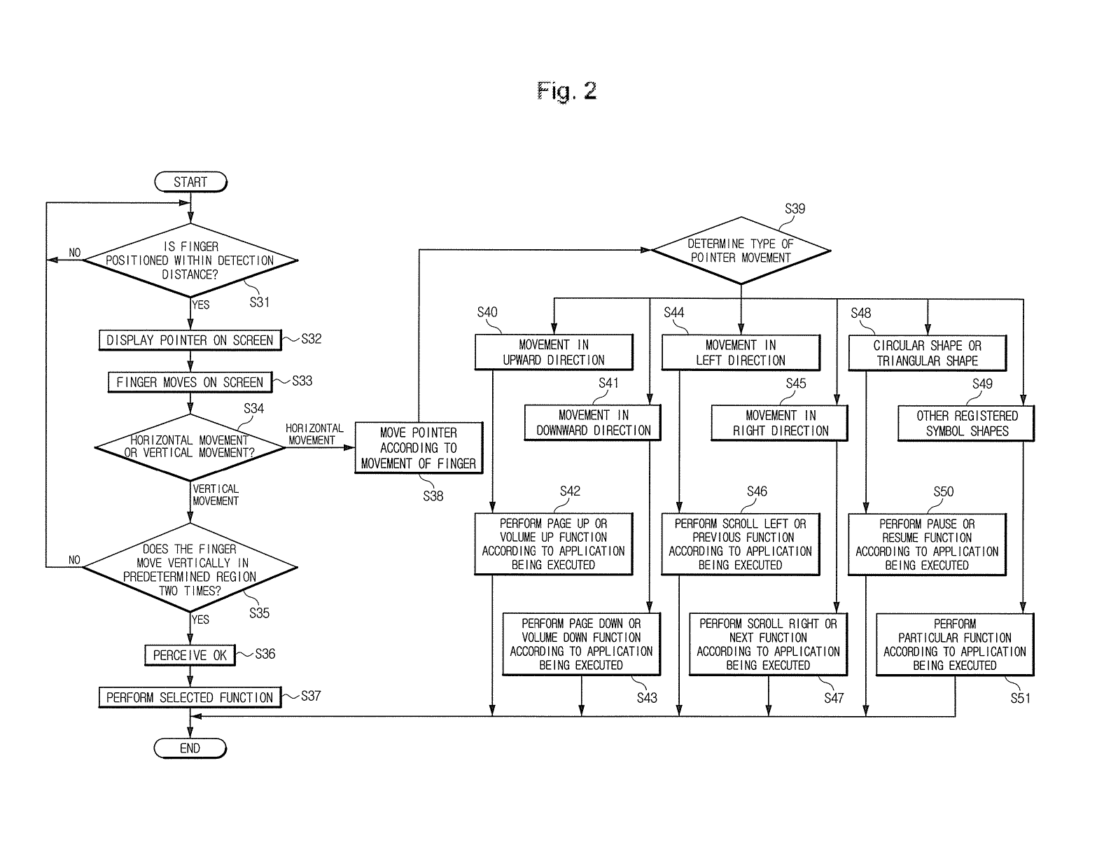

The electronic device 10 having the above-mentioned configuration according to the exemplary embodiment may be operated as illustrated in FIG. 2 if the electronic device 10 is controlled according to the finger movement by detecting the movement of the user's finger without contacting the electronic device. Although FIG. 2 will be described in reference to the electronic device 10 shown in FIG. 1, it is not intended that the method for controlling an electronic device will be limited as such.

First, if the user positions the finger within the detection distance of the infrared temperature sensor 11 (operation S31), the controller 13 detects that the finger is positioned within the detection distance using the infrared temperature sensor 11 and displays the pointer on the screen of the display 17, and specifically, displays the pointer corresponding to the position of the finger on the screen of the display 17 (operation S32).

Then, if the user's finger is moved while within the detection distance of the infrared temperature sensor 11 and while the controller 13 of the portable electronic device 10 displays the pointer on the screen of the display 17 (operation S33), the controller 13 determines whether the movement of the finger is in a horizontal direction or a vertical direction (operation S34).

If the controller 13 determines in the operation S34 that the finger is moved in the vertical direction, the controller 13 determines whether the finger is moved vertically two times (operation S35). If the controller 13 determines that the finger is moved vertically two times, the controller 13 recognizes an “OK” process on the function selected on the screen of the display 17 through the pointer displayed on the screen in the operation S32 (operation S36), and executes the function selected through the pointer on the screen (operation S37).

Otherwise, if the controller 13 determines that the finger moves horizontally in operation S34, the controller 13 displays the movement of the pointer on the screen of the display 17 corresponding to the movement of the finger (operation S38), and checks the type of the movement of the pointer according to the movement of the finger (operation S39).

As a result of checking the type of movement of the pointer by the controller 13 in operation S39, the pointer movement may be determined to be horizontally in the upward direction (operation S40). In this case, the predetermined function according to the application being executed and corresponding with this movement is performed. For example, a page up function of the screen display on the display 17 or a volume up function of a sound source that is being played may be performed (operation S42).

As a result of checking the type of movement of the pointer by the controller 13 in operation S39, the pointer movement may be determined to be horizontally in the downward direction (operation S41). In this case, the predetermined function according to the application being executed and corresponding with this movement is performed. For example, a page down function of the screen display on the display 17 or a volume down function of a sound source that is being played may be performed (operation S43).

As a result of checking the type of movement of the pointer by the controller 13 in operation S39, the pointer movement may be determined to be horizontally in the left direction (operation S44), the predetermined function according to the application being executed and corresponding with this movement is performed. For example, scrolling the screen display on the display 17 to the left or playing a previous sound source may be performed (operation S46).

As a result of checking the type of movement of the pointer by the controller 13 in operation S39, the pointer movement may be determined to be horizontally in the right direction (operation S45). In this case, the predetermined function according to the application being executed and corresponding with the movement is performed. For example, scrolling the screen display on the display 17 to the right or playing a next sound source may be performed (operation S47).

As a result of checking the type of movement of the pointer by the controller 13 in operation S39, the pointer movement may be determined to be horizontally in the circular shape or in the triangular shape (operation S48). In this case, the predetermined function according to the application being executed and corresponding with the movement is performed. That is, pausing the played sound source or resuming the paused sound source may be performed (operation S50).

As a result of checking the type of movement of the pointer by the controller 13 in operation S39, the pointer movement may be determined to be horizontally in other registered symbol shapes (operation S49). In this case, the predetermine function according to the application being executed and corresponding with the movement may be performed (operation S51).

As described above, according to the exemplary embodiment, a user's finger moving within a detection distance of a portable electronic device may be detected even without the finger contacting the display. Then, a pointer moving corresponding to the movement of the user's finger is displayed on the screen of the portable electric device, and a predetermined function corresponding to the movements of the finger is performed. This may permit the user to more easily control the portable electronic device through the movement of the user's finger.

The embodiment may be applied to various electronic devices and portable electronic devices such as a portable media player, a portable DMB TV, and a portable telephone. According to an exemplary embodiment, the electronic device may be controlled according to the movement of a user's finger without contacting the display. This may reduce an input error caused by a different size of the user's finger. In addition, the portable electronic device may be operable without using a touch screen, so that physical damage of the electronic device's screen may be reduced or avoided.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An electronic device, comprising:
an infrared temperature sensor to detect a temperature of infrared emission energy emitted from a user's finger arranged within a detection distance of the infrared temperature sensor, and to output detected temperature information;
a display screen; and
a controller to recognize a position or movement of the user's finger on the basis of the temperature information, and to display on the display screen a pointer corresponding to the position or movement of the user's finger.

2. The electronic device of claim 1, wherein the controller recognizes the movement of the user's finger and performs a predetermined function corresponding to the recognized movement of the user's finger.

3. The electronic device of claim 2, wherein the predetermined function further corresponds to an application executed by the electronic device.

4. The electronic device of claim 2, wherein the predetermined function corresponding to the recognized movement of the user's finger is stored in a memory of the electronic device.

5. The electronic device of claim 1, wherein electronic device is portable.

6. A method for controlling an electronic device, comprising:
detecting a user's finger positioned within a detection distance of an infrared temperature sensor; and
displaying a pointer corresponding to a position of the user's finger on a display screen of the electronic device.

7. The method of claim 6, further comprising:
detecting the user's finger moving in a vertical direction; and
performing a function selected on the display screen by the pointer.

8. The method of claim 6, further comprising:
detecting movement of the user's finger; and
performing a predetermined function corresponding to the detected movement of the user's finger.

9. The method of claim 6, further comprising:
detecting movement of the user's finger in a horizontal direction;
perceiving a type of the movement; and
performing a predetermined function corresponding to the type of the movement.

10. The method of claim 9, further comprising:
displaying movement of the pointer on the display screen corresponding to the movement of the user's finger.

11. The method of claim 8, wherein the predetermined function further corresponds to an application executed by the electronic device.

12. The method of claim 8, wherein the predetermined function corresponding to the detected movement of the user's finger is stored in a memory of the electronic device.

13. The method of claim 6, wherein electronic device is portable.
